(19) United States
(12) Patent Application Publication
(10) Pub. No.: US 2006/0157889 A1
(43) Pub. Date: Jul. 20, 2006

(54) Method for forming indicating device of tool handle

(76) Inventor: Chang-Ying Chen, Taichung Hsien (TW)

Correspondence Address: Chang-Ying Chen, 235 Chung - Ho, Box 8-24, Taipei, TW

(21) Appl. No.: 11/368,008

(22) Filed: Mar. 6, 2006

Related U.S. Application Data
(62) Division of application No. 10/899,429, filed on Jul. 26, 2004.

(51) Int. Cl. B29C 45/14

(52) U.S. Cl. 264/250; 264/245

(57) ABSTRACT

A method serves for forming an indicating device of a tool handle, comprising the step of: placing the driving head in a first mold; forming a first color layer on the driving head by plastic injection; and also forming an indicating portion; wherein two sides of the indicating portion have via holes; placing the driving head into a second mold; but at least one end of the first color layer being exposed out from the second mold; forming a second color layer upon the first color layer within the second mold; wherein the color of the second color layer being different from the first color layer; and injecting color material the same as the second color layer into the via holes, wherein the color material will flow into the indicating portion so that the color the indicating portion has the same color as that of the second color layer.

The present invention is a divisional application of U. S. patent application with Ser. No. 10/899,429 which is invented and assigned to the inventor and applicant of the present invention and thus the contents of the application are incorporated into the present invention as a part of the present invention.

### FIELD OF THE INVENTION

The present invention relates to an indicating device of a tool handle, where different color layers and indicating portion are formed on a handle of a tool driver so that the user can identify the form of the tool driver easily. Moreover, a method for forming the indicating device of a tool handle is also disclosed.

### BACKGROUND OF THE INVENTION

In the prior art, the tool driver is mainly made by a driving head and a handle. The form of the driving head, such as straight form, a cruciform form, or a hexagonal form, is matched to the handle. Since there are various forms of driving heads, the handle is enclosed by plastic material of different colors for identification, for example, there are two layers of different colors or the textures of different forms are formed on the handle. However for users not skilled in the art, they cannot identify drivers. Thereby the color layers loses the function of identification.

### SUMMARY OF THE INVENTION

Accordingly, the primary object of the present invention is to provide an indicating device of a tool handle, where different color layers and indicating portion are formed on a handle of a tool driver so that the user can identify the form of the tool driver easily. Moreover, a method for forming the indicating device of a tool handle is also disclosed.

To achieve above objects, the present invention provides a method for forming an indicating device of a tool handle. The method comprises the step of: placing the driving head in a first mold; forming a first color layer on the driving head by plastic injection; and also forming an indicating portion; wherein two sides of the indicating portion have via holes; placing the driving head into a second mold; but at least one end of the first color layer being exposed out from the second mold; forming a second color layer upon the first color layer within the second mold; wherein the color of the second color layer being different from the first color layer; and injecting color material the same as the second color layer into the via holes and then flows into the indicating portion so that the color the indicating portion has the same color as that of the second color layer.

The various objects and advantages of the present invention will be more readily understood from the following detailed description when read in conjunction with the appended drawing.

### BRIEF DESCRIPTION OF THE DRAWINGS

FIG. 1 is a schematic view of the indicating device of a tool handle of the present invention.

FIG. 2 is a schematic cross view showing the formation of the first color layer of the present invention.

FIG. 3 is a schematic cross view showing that the handle with the first color layer is placed into the second color layer.

FIG. 4 is a schematic cross view of the structure in FIG. 3 which is viewed from another orientation.

FIG. 5 is a schematic cross view of the indicating portion of the present invention.

### DETAILED DESCRIPTION OF THE INVENTION

In order that those skilled in the art can further understand the present invention, a description will be described in the following in details. However, these descriptions and the appended drawings are only used to cause those skilled in the art to understand the objects, features, and characteristics of the present invention, but not to be used to confine the scope and spirit of the present invention defined in the appended claims.

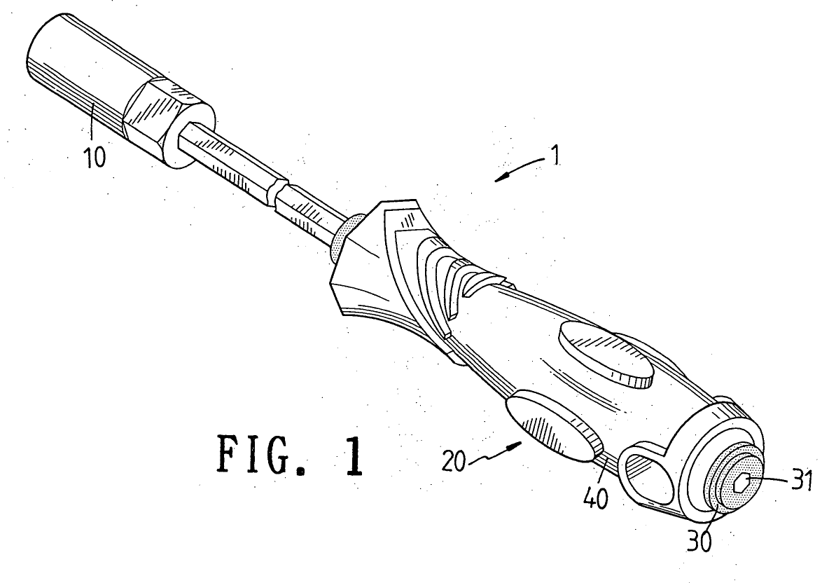

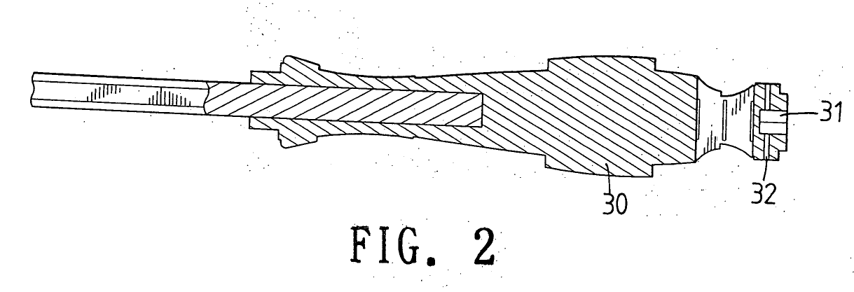

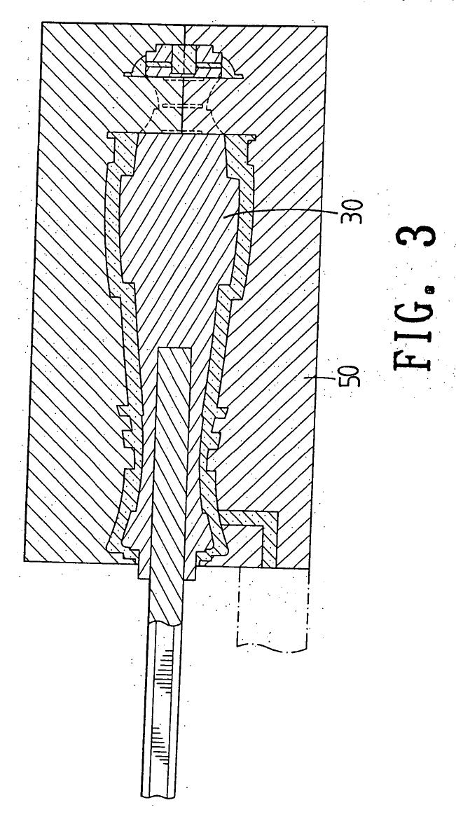

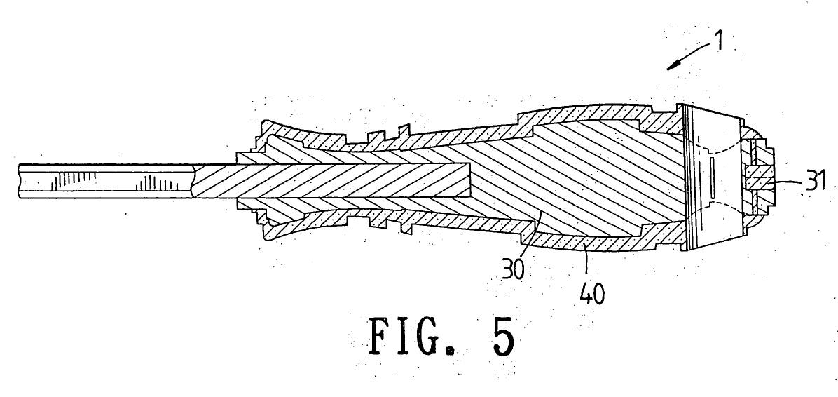

With reference to FIGS. 1 to 5, the indicating device of a tool handle of the present invention is illustrated. The indicating device of a tool handle has the following elements.

A tool body 1 has a hexagonal sleeve driver head 10 (however driver of other shapes, such as a straight shape, a cruciform shape, etc. are allowable in the present invention) at one end of the tool body.

Another end of the tool body is formed with a handle 20. The handle 20 is made by plastic injection.

A first color layer 30 is installed on the handle 20.

A second color layer 40 covers the first color layer 30, but the two ends of the first color layer 30 are exposed out of the second color layer 40. The color of the second color layer 40 is different from that of the first color layer 30. Thereby the user can identify the handle 20 by the different colors of the first color layer 30 and second color layer 40.

The main feature of the present invention is that a bottom end of the first color layer 30 is installed with a shaped indicating portion 31. The shape of the indicating portion 31 is corresponding to the driver head 10 (for example, if the driving head 10 has a cruciform, the indicating portion 31 has a cruciform form). Thereby by the shape of the indicating portion 31, the shape of the driving head 10 can be identified.

Moreover, the indicating portion 31 at the bottom of the first color layer 30 has the same color the second color layer 40. In plastic injection of the second color layer 40, the indicating portion 31 is also injected with the second color layer 40. Thereby the user can identify the indicating device of a tool handle easily.

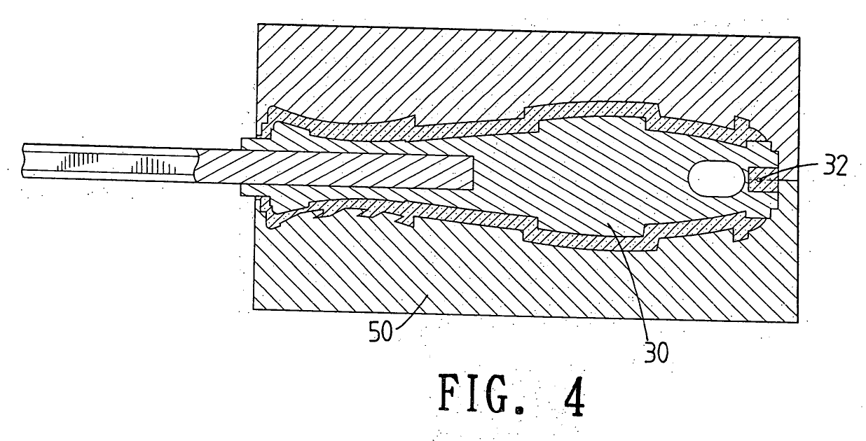

In forming the present invention, the driving head 10 is placed in a first mold (not shown), and then the first color layer 30 is formed on the driving head 10 by plastic injection. The indicating portion 31 is also formed. Two sides of the indicating portion 31 have via holes 32. Then the driving head 10 is placed into a second mold 50, but the two ends of the first color layer 30 are exposed out from the second mold 50. Then a second color layer 40 having a different color from the first color layer 30 is formed upon the first color layer 30. Moreover, see FIG. 4, color material the same as the second color layer 40 is injected into the via holes and then flows into the indicating portion 31 so that the color the indicating portion 31 has the same color as that of the second color layer 40, and the color of the indicating portion 31 is apparently different from that of the first color layer 30. Thus the user can identify the driving head 10 quickly.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A method for forming an indicating device of a tool handle, comprising the step of:
placing the driving head in a first mold;
forming a first color layer on the driving head by plastic injection; and also forming an indicating portion; wherein two sides of the indicating portion have via holes;
placing the driving head into a second mold; but at least one end of the first color layer being exposed out from the second mold;
forming a second color layer upon the first color layer within the second mold; wherein the color of the second color layer being different from the first color layer; and
injecting color material the same as the second color layer into the via holes, wherein the color material will flow into the indicating portion so that the color the indicating portion has the same color as that of the second color layer.
